(19) United States
(12) Patent Application Publication
(10) Pub. No.: US 2009/0200966 A1
(43) Pub. Date: Aug. 13, 2009

(54) ILLUMINATION UNIT WITH CURRENT INTERRUPTER COMPONENT

(75) Inventors: Douglas Bruce Whitehouse, Milton (CA); Kenneth Victor Turner, Port Hope (CA); Oran William McNabb, Burlington (CA)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: AMDOR, INC., Burlington (CA)

(21) Appl. No.: 12/391,132

(22) Filed: Feb. 23, 2009

Related U.S. Application Data
(63) Continuation-in-part of application No. 11/798,648, filed on May 16, 2007.

(51) Int. Cl. H05B 37/00; F21V 33/00; B60Q 1/00

(52) U.S. Cl. 315/309; 362/154; 362/459

(57) ABSTRACT

An illumination unit comprises at least one electrical coupling element for receiving electrical current from a current source and coupling the illumination unit into an electrical system, a light-carrying member, and an electrical circuit adapted for electrical coupling to the current source via the electrical coupling element. The electrical circuit comprises at least one light-emitting diode carried by the light-carrying member, and a current interrupter component interposed in the electrical circuit. The current interrupter component permits current flow within the electrical circuit when a parameter of the electrical circuit remains below a predetermined value, and opens the electrical circuit in response to the parameter of the electrical circuit exceeding the predetermined value. The current interrupter component may be carried by the light-carrying member, or may be contained within an exterior envelope at least partially surrounding the electrical circuit.

### CROSS-REFERENCE TO RELATED APPLICATIONS

This application is a continuation-in-part of U.S. patent application Ser. No. 11/798,648 filed on May 16, 2007.

### FIELD OF INVENTION

The present invention relates to illumination units, and more particularly to safety arrangements for illumination units.

### BACKGROUND OF THE INVENTION

It is common for transport vehicles, such as transport trucks, to have illumination units comprising at least one LED, and typically a plurality of LEDs, for use in illuminating storage compartments (including the main transport compartment) on those vehicles. Typically, a vehicle's lighting systems, including the headlights and the LED-based compartment illumination units, are powered by the vehicle's electrical system, possibly in series, and a circuit breaker is employed. If there is a malfunction in one of the lighting systems, it will tend to draw the maximum current from the battery and, unless otherwise protected, the smaller LED-based compartment illumination units, which are designed for lower amperage, can overheat and cause a fire.

Because the lighting systems, including the LED-based compartment illumination units, can be connected in series, typical current-limiting measures, such as current-limiting diodes, are generally unsuitable. Moreover, while in prior art embodiments of LED-based illuminations units, fuses have been included in the power supply cords for those lighting units, these fuses are often inadvertently removed when the power supply cords are trimmed, or cut off altogether, as part of the installation process, thereby removing the fuse from the electrical circuit of the illumination unit.

Fire department vehicles, such as large aerial trucks, pumper trucks, and the like, often have a large number of compartments, often secured with roll-up exterior doors, in which important firefighting equipment is stored. These vehicles typically carry a significant number of lights, including not only the roof-mounted emergency signaling lights with which most drivers are familiar, but also LED-based illumination units, which can be located inside the storage compartments to provide illumination therein, as well as to provide perimeter lighting, pump panel lighting, step surface lighting, and the like.

While there is obviously a danger to life and property associated with the risk of one of the smaller LED-based compartment illumination units catching fire due to a lighting system malfunction, where the LED-based compartment illumination unit is located on a firefighting vehicle, the danger is even more acute because the fire can hamper the operations of the firefighters at a time when lives hang in the balance. In addition, even if no-one is injured as a result of such a fire and property damage is limited, there is still the ignominy of having a firefighting vehicle catch fire.

### SUMMARY OF THE INVENTION

In one aspect, the present invention is directed to an illumination unit. The illumination unit includes at least one electrical coupling element for receiving electrical current from a current source and coupling the illumination unit into an electrical system, a light-carrying member, and an electrical circuit adapted for electrical coupling to the current source via the electrical coupling element. The electrical circuit comprises at least one light-emitting diode carried by the light-carrying member, and a current interrupter component interposed in the electrical circuit. The current interrupter component permits current flow within the electrical circuit when a parameter of the electrical circuit remains below a predetermined value, and opens the electrical circuit in response to the parameter of the electrical circuit exceeding the predetermined value. The current interrupter component is carried by the light-carrying member.

In an embodiment, the parameter of the electrical circuit is electrical current therein and the current interrupter component is a fuse.

In an embodiment, the current interrupter component is resettable. The current interrupter component may be a polymeric positive temperature coefficient device that uses its internal temperature as a proxy for the electrical current in the electrical circuit and trips when its internal temperature exceeds a predetermined temperature, and which, after being tripped and opening the electrical circuit, automatically resets to close the electrical circuit upon its internal temperature decreasing below the predetermined temperature.

In an embodiment, the current interrupter component is manually resettable.

In an embodiment, the illumination unit may further comprise a translucent tubular cover member in which the light-carrying member is removably mounted. In a particular embodiment, the light-carrying member is removably slidably mounted in the cover member, and the interior of the cover member has radially spaced internal projections positioned to receive the light-carrying member therebetween to maintain the light-carrying member in selectable different angular orientations in the cover member.

A storage compartment having a movable door may include at least one illumination unit as described above mounted on an interior portion of the compartment structure. Such a storage compartment may include a vertically movable door and may include a pair of illumination units as described above mounted in the storage compartment and extending vertically therein adjacent respective opposite sides of the door interiorly thereof. In a particular embodiment, the illumination units are secured to respective door frame members of the storage compartment.

In another aspect, the present invention is directed to an illumination unit. The illumination unit comprises at least one electrical coupling element for receiving electrical current from a current source and coupling the illumination unit into an electrical system, and an electrical circuit adapted for electrical coupling to the current source via the electrical coupling element. The electrical circuit includes at least one light emitting diode and a current interrupter component interposed in the electrical circuit to permit current flow within the electrical circuit when a parameter of the electrical circuit remains below a predetermined value, and open the electrical circuit in response to the parameter of the electrical circuit exceeding the predetermined value. An exterior envelope at least partially surrounds the electrical circuit, and the current interrupter component is contained within the exterior envelope.

In one embodiment, the current interrupter component is carried by a light-carrying member which also carries the at least one light emitting diode.

In another embodiment, the current interrupter component is mounted on an interior surface of the exterior envelope.

In an embodiment, the parameter of the electrical circuit is electrical current therein and the current interrupter component is a fuse.

In an embodiment, the current interrupter component is resettable. In a particular embodiment, the current interrupter component is a polymeric positive temperature coefficient device that uses its internal temperature as a proxy for the electrical current in the electrical circuit and trips when its internal temperature exceeds a predetermined temperature, and which, after being tripped and opening the electrical circuit, automatically resets to close the electrical circuit upon its internal temperature decreasing below the predetermined temperature.

In an embodiment, the exterior envelope permits access to the current interrupter component and the current interrupter component is manually resettable.

In an embodiment, the exterior envelope is at least highly water-resistant and surrounds at least those components of the electrical circuit that would be adversely affected by contact with water. In a particular embodiment, each light-emitting diode is at least highly water-resistant and at least a portion of each light-emitting diode is outside of the exterior envelope to facilitate illumination.

A vehicle may have disposed on an exterior surface thereof at least one illumination unit whose exterior envelope is at least highly water-resistant and surrounds at least those components of the electrical circuit that would be adversely affected by contact with water.

### BRIEF DESCRIPTION OF THE DRAWINGS

These and other features of the invention will become more apparent from the following description in which reference is made to the appended drawings wherein:

FIG. 1 is a perspective view of a first embodiment of an exemplary illumination unit, in accordance with an aspect of the present invention;

FIG. 2 is a top view of the illumination unit of FIG. 1;

FIG. 3 is a side view of the illumination unit of FIG. 1;

FIG. 4 is a bottom view of the illumination unit of FIG. 1;

FIG. 5 is a perspective view of a second embodiment of an exemplary illumination unit, in accordance with an aspect of the present invention;

FIG. 6 is a perspective view of a third embodiment of an exemplary illumination unit, in accordance with an aspect of the present invention;

FIG. 7 is a perspective view of an exemplary light-carrying member partially inserted into a cover member at a pre-determined angular orientation relative thereto in accordance with an aspect of the present invention;

FIG. 8 is a diagrammatic end view showing an angular orientation of the exemplary light-carrying member of FIG. 7 in the cover member;

FIG. 9 is a diagrammatic end view showing the exemplary light-carrying member of FIG. 7 in the same angular orientation within the cover member as in FIG. 8, but viewed from the opposite end;

FIG. 10 is similar to FIGS. 8 and 9 but shows the light-carrying member in another angular orientation in the cover member;

FIG. 11 is an end view showing the light patterns produced by the light-carrying member when in various angular orientations in the cover member;

FIG. 12 is an end view showing the cover member mounted on a suitable support;

FIG. 13 is an end view showing the cover member fitted in a mounting strip;

FIG. 14 is a perspective view of an exemplary storage cabinet;

FIG. 15 is a horizontal sectional view showing two illumination units in accordance with an embodiment of an aspect of the invention mounted in the storage cabinet of FIG. 14 to illuminate the interior thereof;

FIG. 16A is a perspective view of a fourth embodiment of an exemplary illumination unit, in accordance with an aspect of the present invention;

FIG. 16B is a cross-sectional view of the illumination unit of FIG. 16A, taken along the line 16B-16B in FIG. 16A;

FIG. 17 is a perspective view of a fifth exemplary illumination unit partially inserted into a cover member in accordance an aspect of the present invention;

FIG. 18A shows a diagrammatic end view of a first embodiment of a light-carrying member according to an aspect of the present invention which includes an integral protective shroud; and

FIG. 18B shows a diagrammatic end view of a second embodiment of a light-carrying member according to an aspect of the present invention which includes an integral protective shroud.

### DETAILED DESCRIPTION

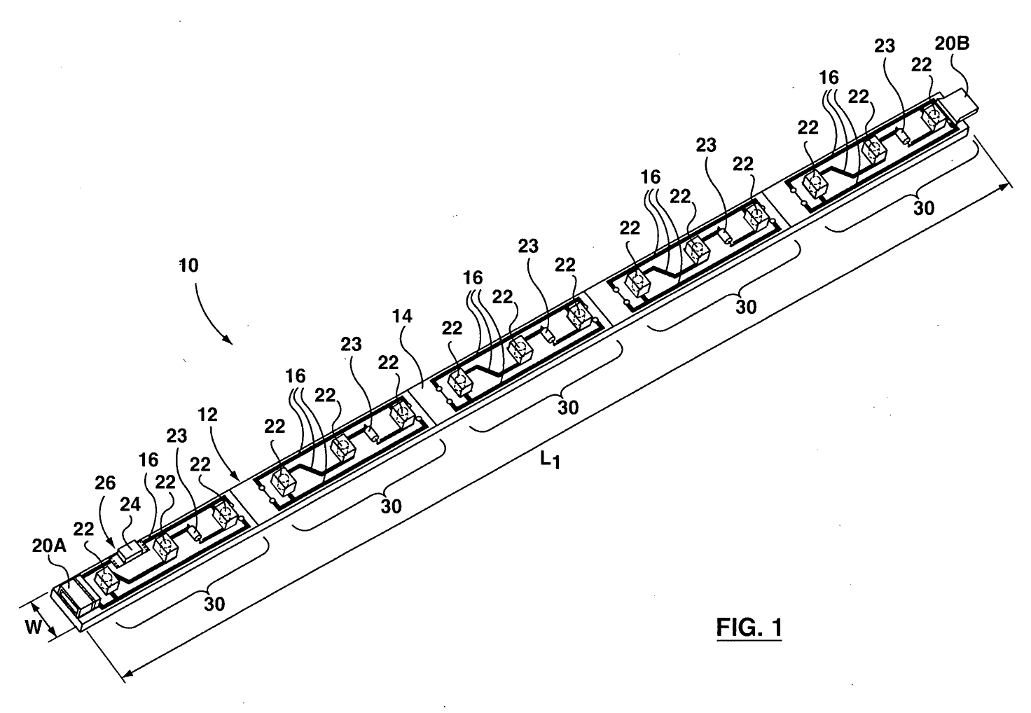

With reference now to FIGS. 1 to 4, an exemplary embodiment of a light-carrying member for an illumination unit in accordance with an aspect of the present invention is indicated generally at 10. While illumination units according to aspects of the present invention may be used in any suitable environment, the exemplary illumination units shown and described herein are particularly well suited for illuminating storage compartments on vehicles, such as firefighting vehicles, transport trucks, and the like. An illumination unit according to an aspect of the present invention may consist simply of a single light-carrying member, such as the light-carrying member 10, or may consist of two or more light-carrying members coupled together. In addition, an illumination unit according to an aspect of the present invention may comprise a combination of one or more such light-carrying members with other components, such a cover member or other exterior envelope, as described below.

The light-carrying member 10 comprises a substrate, which may be made from any suitable material, and may be rigid, substantially rigid with limited flexibility, or substantially flexible. An illumination unit according to an aspect of the present invention also includes an electrical circuit, described in greater detail below, having certain components carried by the substrate. The entire electrical circuit need not be carried by the substrate, and those components which are not carried by the substrate may be carried by other physical elements as long as they are electrically integrated into the electrical circuit. As will be described in greater detail below, the substrate can be mounted directly to a support surface, or alternatively may be housed within an exterior envelope which is mounted, directly or indirectly, to the support surface.

In the illustrated embodiment, the substrate is an elongate rectangular printed circuit board 12, comprising at least one rigid insulating layer 14 having conductive pathways 16 on its upper surface to which electrical components may be attached according to a predefined pattern, thereby forming part of an electrical circuit. In the particular illustrated embodiment, and with particular reference to FIG. 4, the electrical circuit of the illumination unit is completed by conductive strips 18A, 18B on the underside of the single insulating layer 14. In alternative embodiments (not shown), either the conductive pathways or the conductive strips may be disposed between a set of two insulating layers or, where three or more insulating layers 14 are used, the conductive pathways and the conductive strips may both be disposed between (different) sets of insulating layers.

In the illustrated embodiment of an illumination unit, current will travel along one of the conductive strips 18A, 18B, and then travel across to the other conductive strip 18A, 18B by way of one or more parallel connections between the conductive strips 18A, 18B, and then return along the other conductive strip 18A, 18B to the electrical source. The parallel connections between the conductive strips 18A, 18B are defined by a combination of the conductive pathways 16 on the surface of the insulating layer 14 and the electrical components carried by the substrate 12, as will be described in greater detail below. Materials and techniques for the design and manufacturing of printed circuit boards are well known in the art and are not discussed further herein.

The illumination unit further includes first and second electrical coupling elements. In the illustrated embodiment, electrical coupling elements 20A, 20B are carried by the substrate 12 and are disposed at opposed ends of the substrate 12 for receiving electrical current from a current source (not shown) and coupling the illumination unit into an electrical circuit. Thus, by securing corresponding electrical coupling elements (not shown) to the electrical coupling elements 20A, 20B on the substrate 12, the illumination unit 10 can be integrated into a larger electrical system. For example, the larger electrical system could include connection wiring wherein the wire harnesses are complementary to one or both of the electrical coupling elements 20A, 20B.

Where the electrical system into which the illumination unit is to be integrated is the electrical lighting system on a vehicle, the current source would typically be the vehicle battery, or the vehicle alternator, or the vehicle's electrical system generally. Alternatively, the current source may be a rectified AC current or a rectifier may be included as part of the illumination unit so that it can be coupled to an AC current source.

In the particular embodiment illustrated herein, the first electrical coupling element 20A is a male connector carrying electrical connection pins, and the second electrical coupling element 20B is a female connector and the electrical coupling elements 20A, 20B are complementary to one another so that a first illumination unit according to the illustrated embodiment 10 can optionally be physically and electrically coupled to a second illumination unit according to the illustrated embodiment, as will be described further below.

In the particular illustrated embodiment of an illumination unit 10, the electrical coupling elements 20A, 20B are separate pieces that are attached to the substrate at opposed ends thereof, by gluing the pieces and soldering the electrical connections to the printed circuit board 12. It is to be appreciated that this is merely one exemplary implementation, and that in other embodiments (not shown) the electrical connectors may be integrally formed as part of the substrate 10, or may not be directly attached to the substrate, such as where wires having electrical connectors at one end have their other ends electrically connected to the conductive pathways on the printed circuit board. In addition, the electrical coupling elements of an illumination unit according to an aspect of the present invention need not be specially designed components, and may in cruder embodiments simply be wires connected to the circuit, or locations on the substrate to which wires or other elements of a larger electrical system may be connected. All that is required is that the electrical coupling elements enable the integration of the relevant illumination unit into the electrical system of which it will form a part.

As noted above, the exemplary illumination unit includes an electrical circuit, formed in part by the conductive pathways 16 on the upper surface of the insulating layer 14 of the printed circuit board 12. The electrical circuit further comprises at least one, and preferably a plurality of, light-emitting diodes (LEDs) 22 carried by the substrate 10. In the illustrated embodiments, a plurality of LEDs is used. The LEDs 22 may be, for example, model no. ES-CEBLM13-B manufactured by Epistar Corporation, having an address at 5 Li-Hsin 5^{th} Road, Science-Based Industrial Park, Hsin-Chu, Taiwan 300, ROC. Where the substrate is a printed circuit board, the LEDs 22 may be secured to the upper surface of the insulating layer 14 by conventional means such as soldering.

The electrical circuit of the exemplary illumination unit 10 further comprises a current interrupter component 24 carried by the substrate 12 and which is interposed in the electrical circuit of the illumination unit. The purpose of the current interrupter component 24 is to control whether or not current flows within the circuit, based on the state of a particular parameter to which the current interrupter component 24 is responsive. As long as the parameter of the electrical circuit to which the current interrupter component 24 is responsive remains below a predetermined value, the current interrupter component 24 permits current flow within the electrical circuit. Responsive to the parameter of the electrical circuit exceeding the predetermined value, the current interrupter component opens the electrical circuit, so that no further current can effectively flow.

In the illustrated embodiment, the current interrupter component 24 is interposed in the electrical circuit by installation on the upper surface of the insulating layer 14 across a first gap 26 in one of the conductive pathways 16 and a co-located second gap 28 (see FIG. 4) in the conductive strip 18B. Thus, current within the electrical circuit of the illumination unit 10 is denied any alternate electrical path past the current interrupter component 24. More particularly, current traveling along the conductive strip 18B cannot move past the gap 28, so it moves to the portion of the conductive path 16 disposed above that portion of the conductive strip 18B. The current in this portion of the conductive pathway 16 cannot move past the gap 26 therein, and is forced to travel through the current interrupter component 24 in order to complete the circuit.

The parameter of the electrical circuit to which the current interrupter component 24 is responsive will typically be one which indicates a risk of fire, such as the current of the electrical circuit or the heat of a particular component of the electrical circuit, and the predetermined value will be selected on this basis. Accordingly, by opening the electrical circuit in response to the parameter exceeding the predetermined value, the current interrupter component 24 serves to protect the electrical circuit of the illumination unit 10 and substantially reduce the risk of fire. Because the current interrupter component 24 is carried by the substrate, which also carries the LEDs 22, it is extremely unlikely to be accidentally removed from the electrical circuit of the illumination unit 10 during installation thereof, thereby providing for increased safety. In this sense, if the current interrupter component 24 were to be mounted on a separate member secured to the light-carrying member, rather than directly to the light-carrying member, it would still be considered to be “carried by” the light-carrying member.

In the illustrated embodiment of an illumination unit 10, the current interrupter component 24 is a fuse, and the parameter of the electrical circuit to which the fuse is responsive is the electrical current in the electrical circuit.

One particularly suitable type of fuse is a polymeric positive temperature coefficient device (PPTC), typically referred to (and referred to herein) as a resettable fuse. A resettable fuse uses its internal temperature as a proxy for the electrical current in the electrical circuit, in the sense that as the current passing through the resettable fuse increases, its internal temperature also increases, which, because of the way the resettable fuse is constructed, causes its resistance to increase. The resettable fuse effectively “trips” when its internal temperature exceeds a predetermined temperature, which causes the resistance of the resettable fuse to massively increase and effectively open the circuit (even though a small amount of current may still be flowing). The predetermined temperature for the resettable fuse will correspond generally (with slight variations based on ambient conditions) to a predetermined current. After having been tripped, once power to the resettable fuse has been cut, the resettable fuse will quickly cool and thereby return to a resistance close to its nominal resistance, so that current can flow through the resettable fuse once the fault is removed from the circuit and power is restored. Thus, after being tripped and opening the electrical circuit, the resettable fuse automatically resets to close the electrical circuit upon its internal temperature decreasing below the predetermined temperature.

One resettable fuse suitable for use in the exemplary illumination unit 10, particularly where the LEDs are Epistar ES-CEBLM13-B LEDs, is a FSMD200 fuse offered by Tyco Electronics Corporation, having an address at 1050 West Lakes Drive, Berwyn, Pa., 19312, U.S.A. According to the data sheet supplied by the manufacturer, the FSMD200 fuse is designed to operate at up to approximately 2.00 amperes, to trip at approximately 3.50 amperes, and to trip within approximately 2 seconds at a current at or above 8 amperes, in each case at 23° C. Of course, other suitable resettable fuses may also be used.

Moreover, it will be appreciated that other current interrupter components besides resettable fuses may also be used. For example, suitable conventional fuses may be used, and it is within the contemplation of the inventors that circuit-breakers of conventional design could be adapted for use with illumination units according to aspects of the present invention, such adaptation being believed to be within the capability of one skilled in the art, once informed by the herein disclosure. Moreover, it is expressly contemplated that embodiments of the invention may be constructed using current interrupter components developed subsequent to the filing date hereof. Furthermore, it is to be understood that the term “current interrupter component” is not limited to an individual component, but encompasses an assembly of subcomponents which achieves the aforesaid function. It will be appreciated that the characteristics of the relevant current interrupter component should be selected based on characteristics of the electrical circuit as a whole, including the other components thereof. Such selection is within the capability of one skilled in the art once informed by the disclosure hereof.

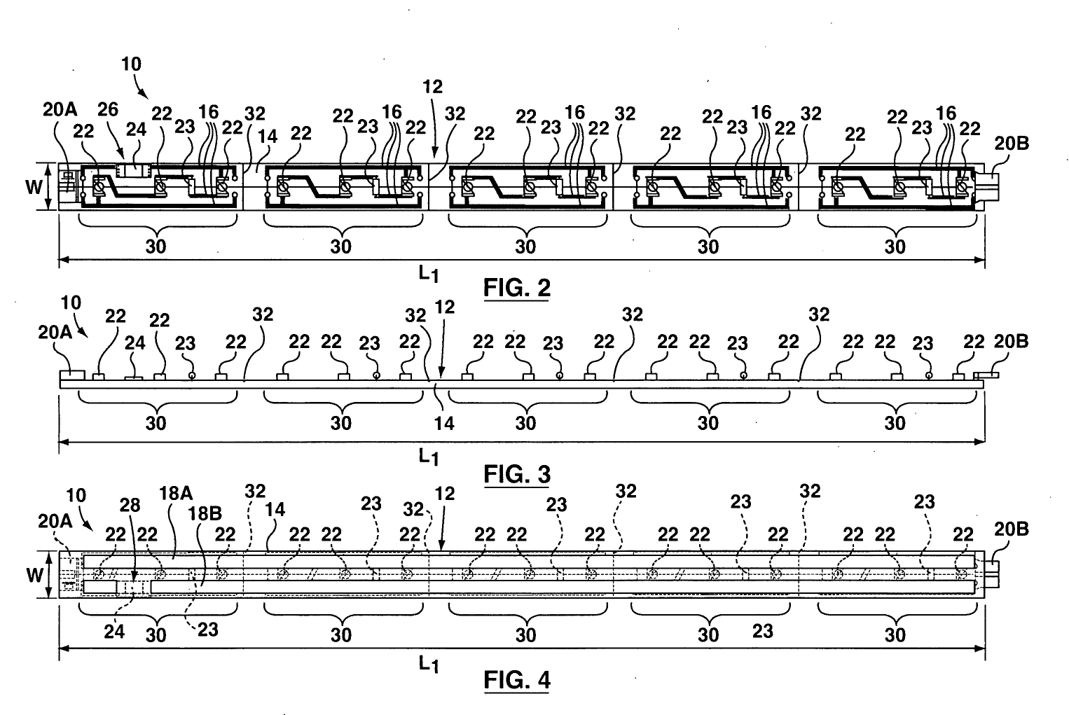

Referring now in particular to FIGS. 1 and 2, in the exemplary embodiment, it can be seen that the conductive pathways 16 and the LEDs 22 on the printed circuit board 12 are divided into individual sub-circuits 30 each comprising three LEDs 22 and a resistor 23 of suitable resistance, with the LEDs 22 and the resistor 23 in each sub-circuit 30 being connected in series. Other configurations for the sub-circuit assemblies may also be used.

The individual sub-circuits 30 provide parallel connections between the conductive strips 18A, 18B on the underside of the printed circuit board 14 (as best seen in FIG. 4). Thus, as described above, a light-carrying member 10 can be electrically coupled to a second light-carrying member 10 (not shown) by coupling the male electrical coupling element 20A on one light-carrying member 10 to the female electrical coupling element 20B on the other light-carrying member 10. The result will be that the conductive strips 18A, 18B on the underside of each light-carrying member 10 will be electrically connected to their respective counterparts. Thus, the two conductive strips 18A are electrically connected to one another and the two conductive strips 18B are electrically connected to one another, forming a larger parallel circuit with the individual sub-circuits 30 on both light-carrying members 10 forming the parallel connections between the conductive strips 18A, 18B. This process of connecting illumination units together can be extended to include a third illumination unit, fourth illumination unit, and so on.

Moreover, the use of individual sub-circuits 30 allows for one or more “standard” sizes of light-carrying member, such as exemplary light-carrying member 10, to be adapted to a variety of circumstances. For example, the exemplary light-carrying member 10 comprises five sub-circuits 30, so that it carries a total of fifteen LEDs. If it were determined that the exemplary light-carrying member 10 were too long for a given application, it could be easily shortened, without loss of functionality, by removing lengths corresponding to one or more individual sub-circuits 30 from the end having the female electrical coupling element 18B. For example, a length corresponding to two individual sub-circuits 30 could be removed, leaving a shortened illumination unit comprising three sub-circuits 30 so that the light-carrying member 10 carries nine LEDs (not shown). The shortened illumination unit would still be functional because the conductive strips 18A, 18B on the underside of the insulating layer 14 would be connected to one another in parallel by the remaining three sub-circuits 30. Additionally, because the current interrupter component 24 forms part of the first sub-circuit 30 (that is, the sub-circuit 30 closest to the male connector 18A), even removing all of the other sub-circuits 30 would still leave the current interrupter component 24 as part of the electrical circuit of the shortened light-carrying member 10. To facilitate removal of lengths corresponding to one or more individual sub-circuits 30, v-cuts or grooves 32 are defined in the printed circuit board 12 between the individual sub-circuits 30.

Light-carrying members according to aspects of the present invention may have a variety of shapes and sizes. The exemplary light-carrying member 10 described above carries five sub-circuits 30 having three LEDs each, for a total of fifteen LEDs, and has a length L₁ of 234.77 millimeters, a width W of 11.43 millimeters, and the printed circuit board 12 has a thickness of 6 millimeters. Each of the LEDs is spaced 15.64 millimeters from the next neighboring LED, whether within the same sub-circuit 30 or in an adjacent sub-circuit 30.

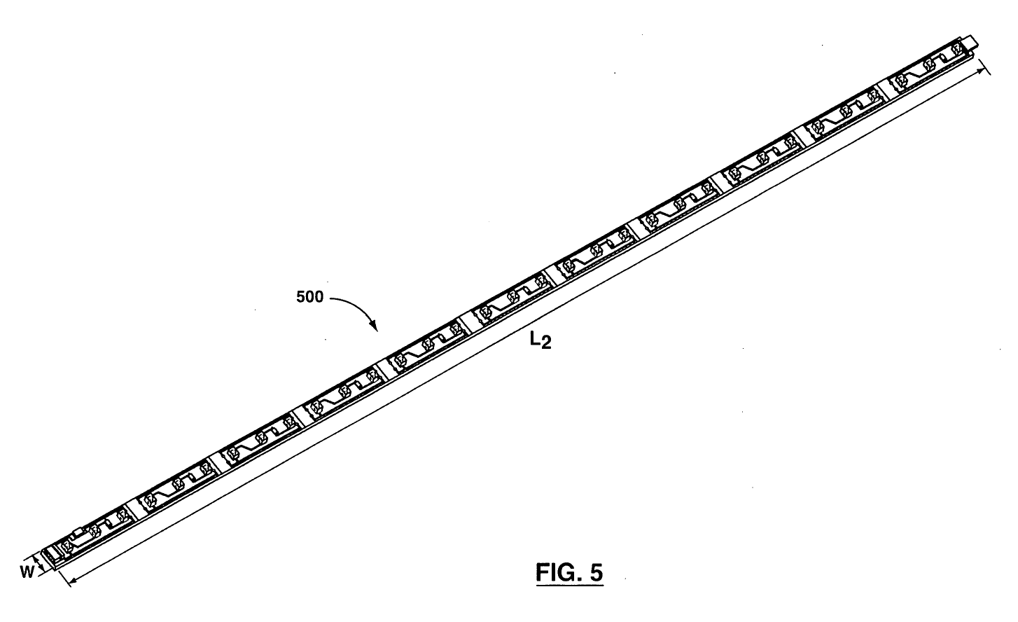

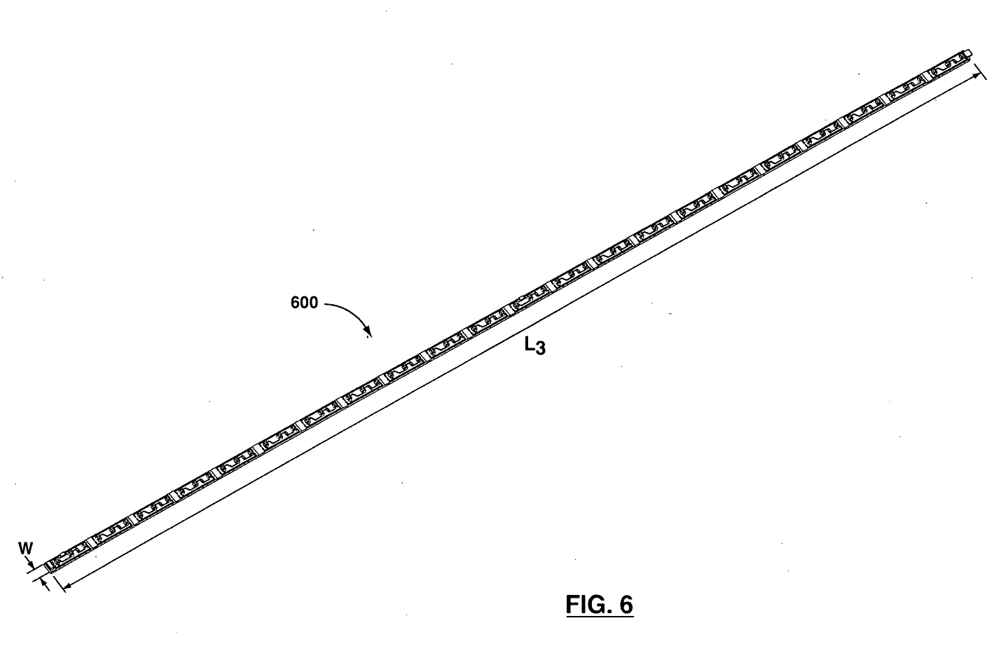

A second embodiment of a light-carrying member 500, shown in FIG. 5, has an identical construction to that of the first embodiment 10, with the same width and thickness, except that it has a length L₂ of 516.11 millimeters and includes eleven sub-circuits having three LEDs each, for a total of thirty-three LEDs. Similarly, a third embodiment of a light-carrying member 600, shown in FIG. 6, is substantially identical to the first and second embodiments 10, 500 except that it has a length L₃ of 1032.2 millimeters, and carries twenty-two sub-circuits having three LEDs each, for a total of sixty-six LEDs.

The first, second and third embodiments 10, 500, 600 described above may be operated at a working voltage of 12V, with a working current of 100 mA, and as such are suitable for integration into a vehicle lighting system to light a storage compartment on the vehicle. Embodiments of aspects of the present invention may also be used other voltages, such as 24V, 110V, 220V, 575V etc., with suitable modification of the components to accommodate such different voltages. Such modifications are within the capability of one skilled in the art, once informed by the herein disclosure.

Light-carrying members according to aspects of the present invention need not take the form of elongate strips such as exemplary light-carrying members 10, 500, 600. Light-carrying members according to an aspect of the present invention may, for example, be circular, ovoid, triangular, pentagonal, hexagonal, or have any other suitable two-dimensional or three-dimensional shape.

Where an illumination unit according to an aspect of the present invention is to be used in situations where there is little or no risk of adverse impact from environmental factors (e.g. inside a climate-controlled transport truck or an indoor facility), the illumination unit may consist simply of one or more light-carrying members, integrated into the larger electrical system, without additional components. In such embodiments, the substrate, which in the illustrated embodiments is a printed circuit board 12, may be adapted for temporary or permanent mounting on a surface, such as a wall or ceiling of a vehicle storage compartment. Such mounting may be for example by adhesive, bolts, screws, or other suitable techniques.

Alternatively, and particularly where an illumination unit according to aspects of the present invention is to be used in less hospitable environments (such as in a storage compartment on a firefighting vehicle, where exposure to water spray is likely), it is preferable to house the light-carrying member, and hence the electrical components carried thereby, in a protective shroud.

In one embodiment, a suitably shaped light-carrying member according to an aspect of the present invention may be housed within an elongated translucent (i.e. completely or partially transparent) tubular cover member as taught by co-pending U.S. patent application Ser. No. 11/798,648 which was published as U.S. Patent Application Publication No. 2008/0285264 A1, the teachings of which are hereby incorporated by reference in their entirety. Accordingly, such an illumination unit would comprise a light-carrying member, such as one of the exemplary light-carrying members 10, 500, 600, together with a cover member as described below.

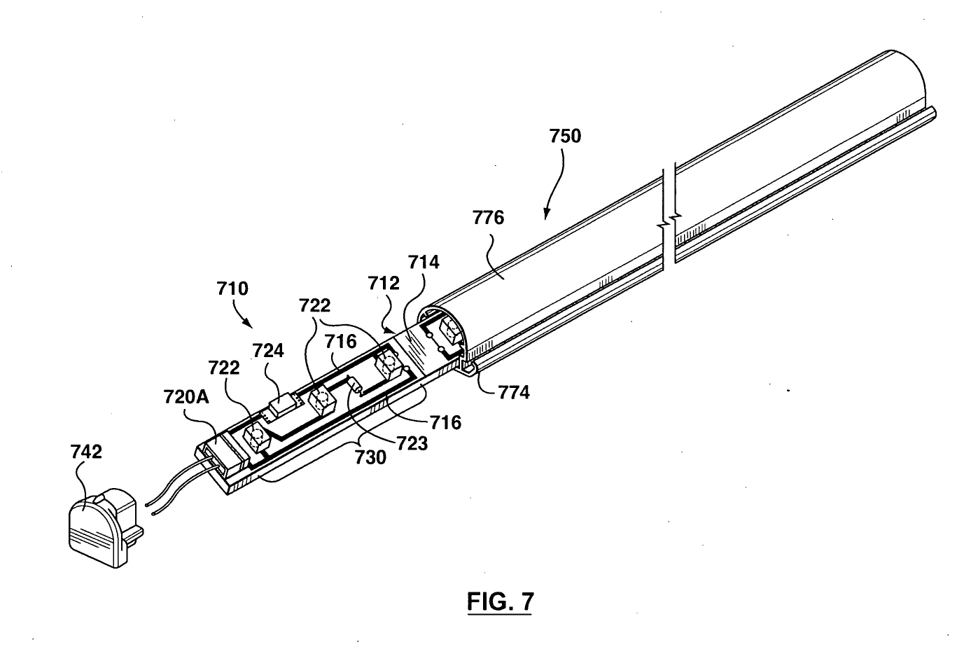

Referring now to FIG. 7 of the accompanying drawings, an illumination unit 700 comprises an elongated light-carrying member 710 (such as light-carrying member 10, 500 or 600 as described above), and an elongated translucent (i.e. completely or partially transparent) tubular cover member 750. Accordingly, the light-carrying member 710 comprises an elongated substrate taking the form of an elongate printed circuit board 712 having at least one rigid insulating layer 714 on the upper surface of which are arranged a plurality of sub-circuits 730. Each sub-circuit 730 includes electrical pathways 716, three LEDs 722 and a resistor 723, all carried on the upper surface of the rigid insulating layer 714 of the printed circuit board 712. As noted above, other sub-circuit configurations may also be used. The first sub-circuit 730 also includes a current interrupter component 724. Conductive strips (not shown in FIG. 7) extend along the underside of the printed circuit board 712 as described above in respect of the light-carrying member 10, and include a gap (not shown in FIG. 7) aligned with the current interrupter component 724. Electrical coupling elements are secured to the printed circuit board 712 at opposed ends thereof (only one electrical coupling element 720A is shown in FIG. 7), and wires 740 extend from the electrical coupling elements to connect the light-carrying member 710 to the larger electrical circuit into which it is to be integrated. A cap 742, containing passageways for the wires 740, may be used to close each end of the cover member 750 and thereby secure the light-carrying member 710 therewithin and provide additional protection from environmental factors.

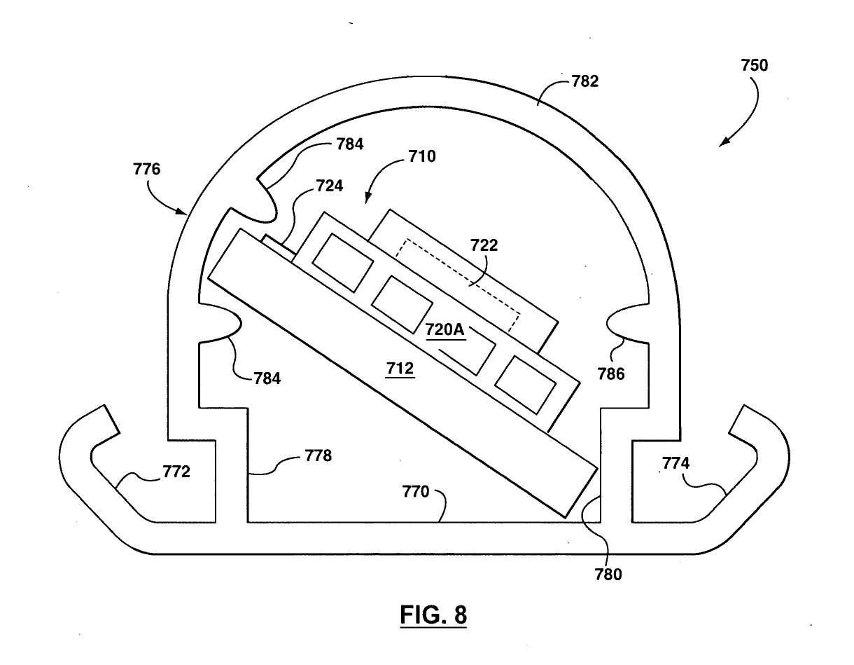

Referring now also to FIGS. 8, 9 and 10, the cover member 750 has a longitudinally extending base portion 770 with upward inclined side portions 772, 774. A cover portion 776 extends upwardly from the central part of the base portion 770. The cover portion 776 has a lower part with a pair of transversely spaced walls 778, 780 and a dome part 782 extending between the side walls 778, 780. The dome part 782 has radially spaced ribs 784, 786 which project inwardly. In particular, the portion of the dome part 782 adjacent the side wall 778 has two radially spaced ribs 784, and the portion of the dome part 782 adjacent the side wall 780 has a single rib 786 which is radially spaced from the other two ribs 784. The inwardly projecting ribs 784, 786 support the light-carrying member 710 in different angular orientations, as will be described shortly. The inwardly projecting ribs 784, 786 also serve to strengthen the dome portion 782 against impact damage, and the presence of only a single rib 786 on the portion of the dome part 782 adjacent the side wall 780 assists in producing a desired light pattern from the LEDs 722.

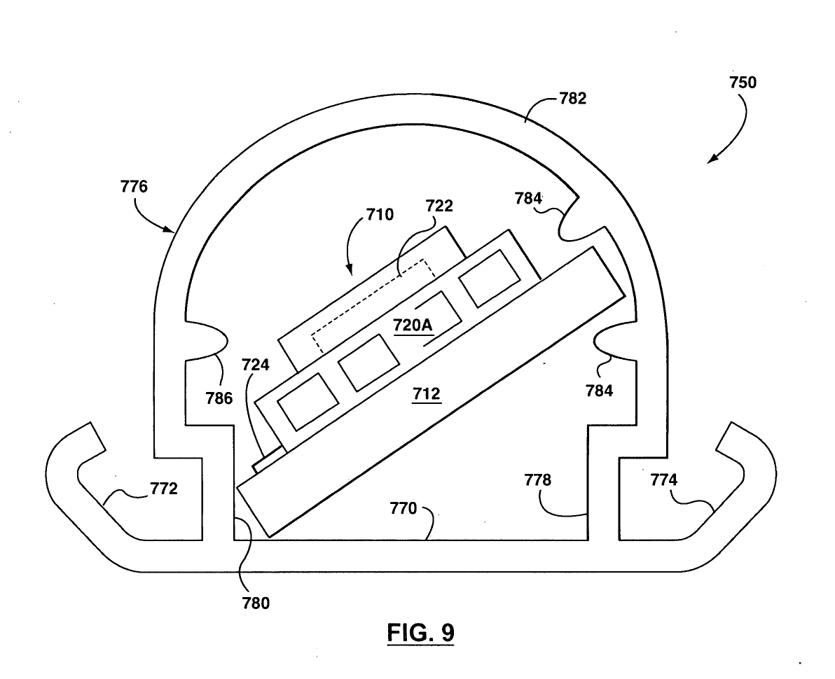

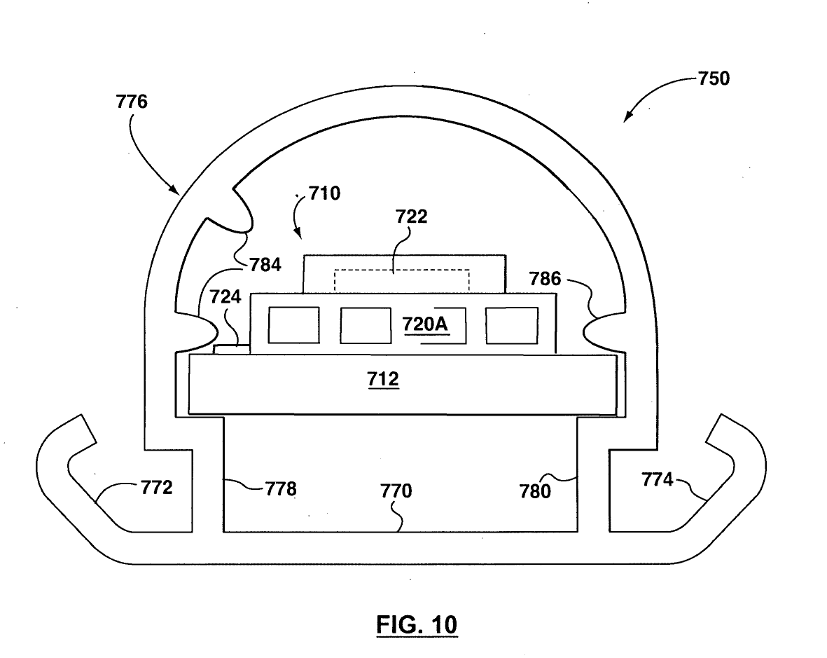

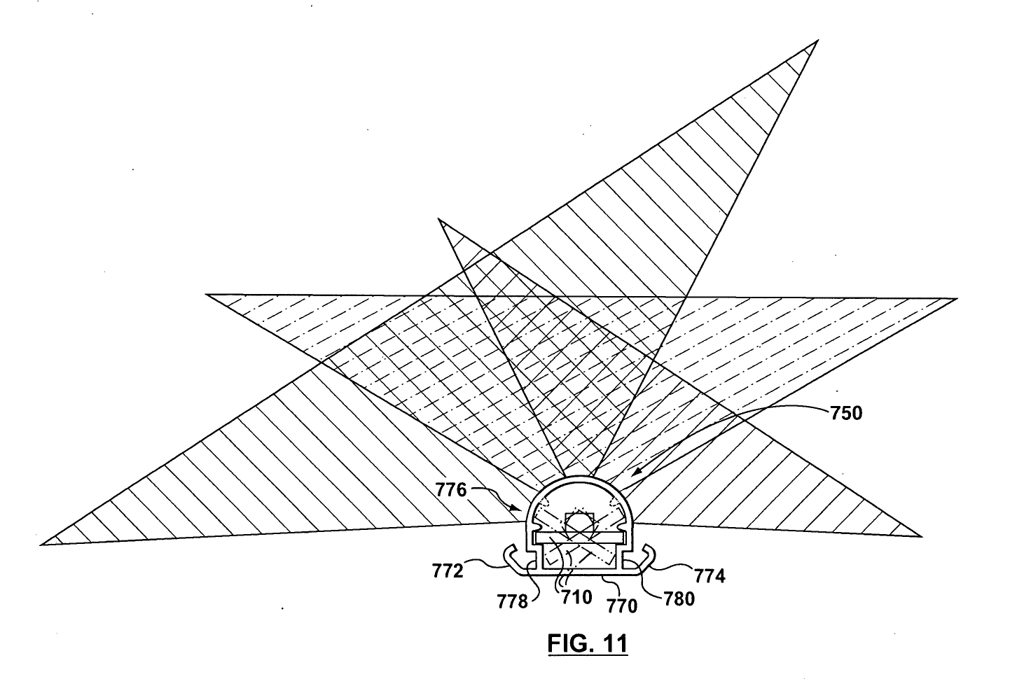

FIG. 8 shows the light-carrying member 710 located in the cover member 750 at a first inclined angle, with the edge of the light-carrying member 710 received between the two ribs 784 on the portion of the dome part 782 adjacent the side wall 778. To orient the light-carrying member 10 at another inclined angle, in particular at an angle that is the mirror image of the angle shown in FIG. 8, the cover member 750 would be rotated 180 degrees about an axis perpendicular to the plane defined by the base portion 770, and the light-carrying member again slid into the cover member 750 with the edge of the light-carrying member 710 received between the two ribs 784 on the portion of the dome part 782 adjacent the side wall 778, as shown in FIG. 9. Because of the rotation of the cover member 750, the light-carrying member 710 is now oriented at an angle that is the mirror image of the angle shown in FIG. 8, even though its edge is between the same ribs 784. FIG. 10 shows the light-carrying member 710 located horizontally in the cover member 750, with the edges of the light-carrying member 710 received between the side wall 778 and the innermost rib 784, and between side wall 780 and the single rib 786. FIG. 11 shows the different light patterns which can be obtained by mounting the light-carrying member 710 within the cover member 750 in the different angular orientations just described. While the exemplary cover member 750 includes three ribs 784, 786 supporting three angular positions of the light-carrying member 710 within the cover member 750, where the size and shape of the light-carrying member and cover member permit, a greater or lesser number of inwardly projecting ribs may be included to support a greater or lesser number of angular positions of the light-carrying member.

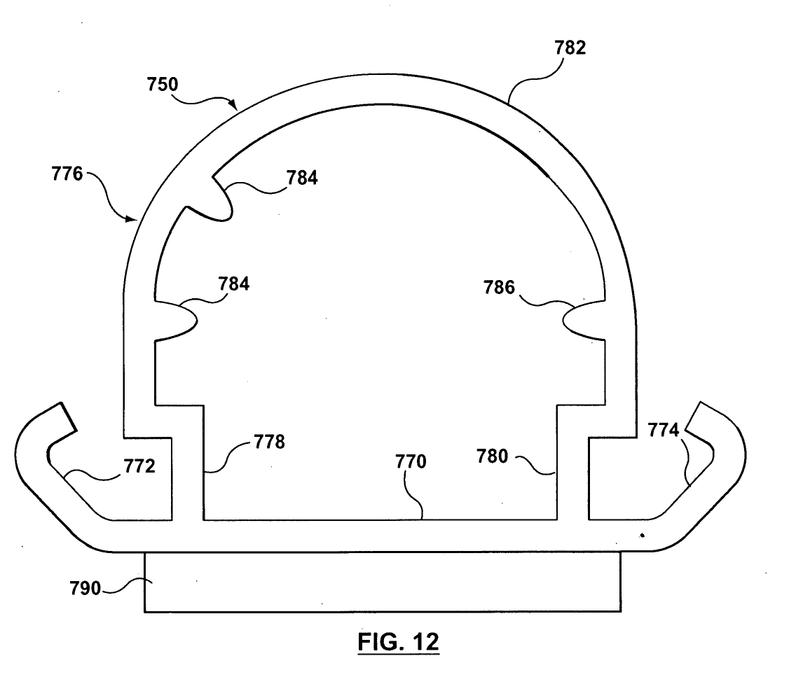

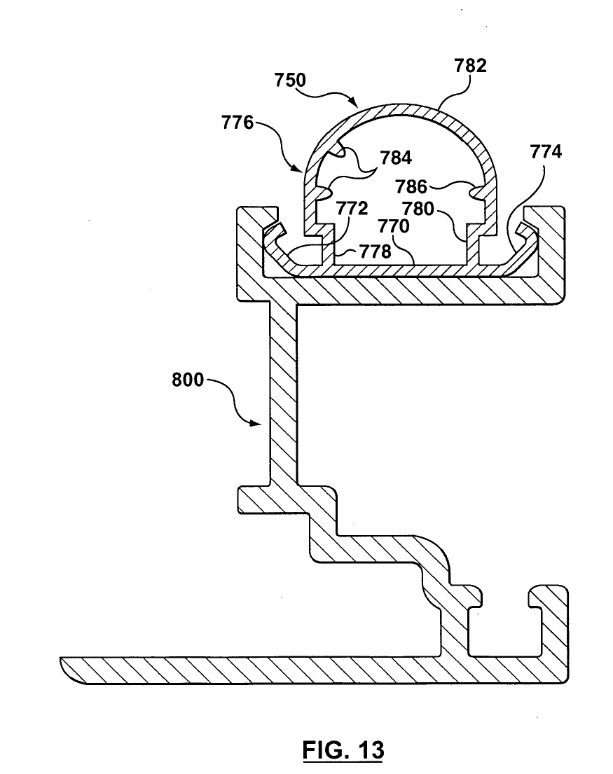

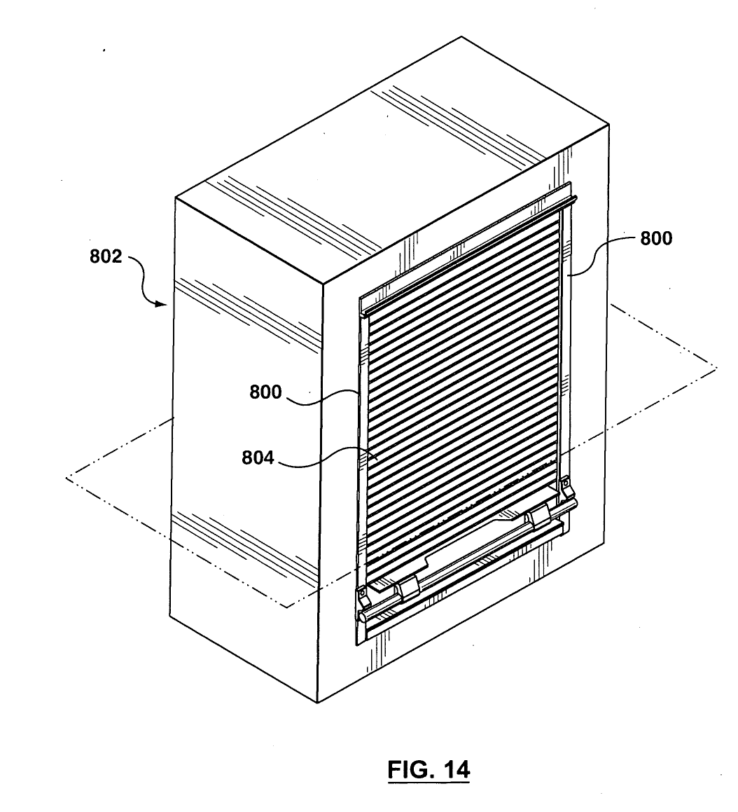

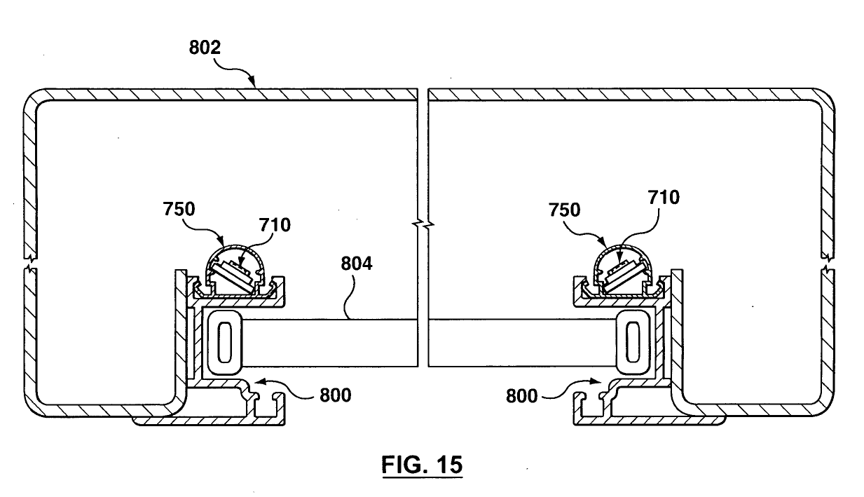

FIG. 12 shows how the cover member 750 can be mounted on a simple base member 790, and FIG. 13 shows how the cover member 750 can be mounted on a door frame member such as a bracket 800 for installation in a location where such a bracket is required. FIGS. 14 and 15 show such an installation, namely in a storage compartment 802 with a vertically movable door 804. The storage compartment 802 may be, for example, a storage compartment on a vehicle. The sides of the door 804 slide in the brackets 800 in the manner shown in FIG. 15, which also shows two illumination units in accordance with an aspect of the invention mounted vertically in the brackets 800 in the manner shown in FIG. 13, i.e. with the cover members 750 secured to the respective brackets 800 adjacent opposite sides of the door 804. In alternate embodiments, a storage compartment door could be a horizontally sliding door, or a hinged door, and one or more illumination units in accordance with an aspect of the invention may be mounted at any suitable position on the interior of the compartment structure. Illumination units according to aspects of the invention may also be mounted and used inside temporary and permanent buildings, such as warehouses. Moreover, suitable illumination units according to aspects of the present invention may be mounted anywhere on a vehicle, such as in a vehicle cab, or, where suitable water resistance is provided such as is described below, on the exterior of a vehicle to provide perimeter lighting.

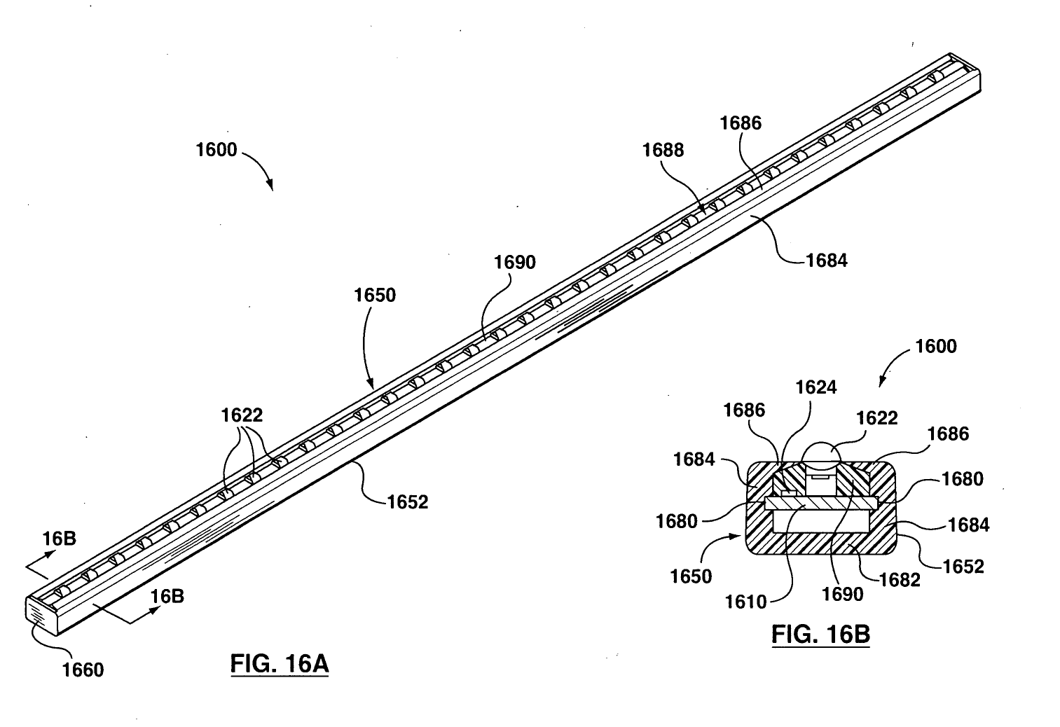

Another embodiment for an illumination unit according to an aspect of the present invention is shown in FIGS. 16A and 16B. More particularly, FIGS. 16A and 16B show an exemplary embodiment of a waterproof or at least water-resistant illumination unit 1600, which is suitable for use, for example, in perimeter lighting for a vehicle.

A light-carrying member 1610 (not shown in FIG. 16A) similar to the light-carrying member 10 described above has disposed thereon a plurality of waterproof, or at least highly water-resistant, LEDs 1622 as well as a current interrupter component 1624 (not shown in FIG. 16A). The waterproof or highly water-resistant LEDs 1622 may be, for example, those marketed under the trademark “Piranha” and which are available at least from Fredlighting Technology Limited, Building 13, Part 2, Jingbei Village, Shiyan Town, 518108, Baoan District, China. The current interrupter component may be, for example, a FSMD200 fuse offered by Tyco Electronics Corporation as described above. The light-carrying member 1610 is received within an exterior envelope 1650 which comprises a C-shaped extrusion 1652 of waterproof or highly water-resistant plastic having opposed inner longitudinal grooves 1680 for receiving the longitudinal edges of the light-carrying member 1610. More particularly, the C-shaped extrusion 1652 comprises a base 1682, two opposed sidewalls 1684 in which the longitudinal grooves 1680 are defined, and two opposed flanges 1686 generally facing the base 1682 and defining a longitudinal gap 1688 therebetween. When the light-carrying member 1610 is received within the C-shaped extrusion 1652, the waterproof or highly water-resistant LEDs 1622 emerge from the exterior envelope 1650 through the longitudinal gap 1688. Waterproof or highly water-resistant end caps 1660 are secured at each end of the C-shaped extrusion 1652, and a suitable waterproof or highly water-resistant sealant 1690, such as an atmospheric temperature vulcanizing/room temperature vulcanizing silicone sealant, is applied through the longitudinal gap 1688 to fill the volume defined by the upper surface of the light-carrying member 10, the upper portions of the sidewalls 1684, the flanges 1686 and the gap 1688. Once the sealant 1690 has cured, all of the electrical pathways and electrical components, other than the upper portions of the waterproof or highly water-resistant LEDs 1622, are sealed inside the sealant 1690, and the conductive strips are sealed by the end caps 1660 and C-shaped extrusion 1652. To facilitate illumination, the upper portions of the waterproof or highly water-resistant LEDs are outside the exterior envelope 1650. Thus, the C-shaped extrusion 1652, end caps 1660 and sealant 1690 cooperate to define the exterior envelope 1650 which surrounds those components of the electrical circuit that would be adversely affected by contact with water, so that those components, including the current interrupter component, are contained within the exterior envelope 1650. The current interrupter component in particular is sealed within the sealant 1690. As such, in waterproof or water-resistant embodiments as described above, the current interrupter component is preferably one which automatically resets, such as a resettable fuse. The exterior envelope 1650 is waterproof or at least highly water-resistant. Of course, wires (not shown) with waterproof or water-resistant insulation would emerge from either the end caps 1660 or the sealant 1690 to couple the illumination unit 1600 to a larger electrical system or a suitable power source. In certain alternative embodiments, where the sealant used is sufficiently translucent, the LEDs may be entirely encapsulated within the sealant, and such LEDs need not be waterproof or water-resistant, since they will be protected by the sealant.

In the above-described embodiments, the light-carrying members 10, 710, 1610 have included a plurality of LEDs 22, 722, 1622 respectively. It is to be appreciated that in other embodiments, depending on the illumination requirements, a light-carrying member may carry only a single LED, without departing from the scope of the present invention. Moreover, while it is often advantageous to use LEDs which emit white light, LEDs that emit other colors may also be used, and LEDs in various combinations of colors, and of white light and colors, may be used.

In the embodiments described in FIGS. 7 to 16B, a protective shroud defines an exterior envelope which surrounds the light-carrying member. In FIGS. 7 to 15, the protective shroud which defines the exterior envelope is the cover member 750, which surrounds the light-carrying member 710. In the embodiment shown in FIGS. 16A and 16B, the protective shroud which defines the exterior envelope 1650 is the combination of the C-shaped extrusion 1652, the end caps 1660 and the sealant 1690. Thus, in both cases, LEDs and other parts of an electrical circuit, namely the conductive pathways, resistors, conductive strips and the current interrupter component, are surrounded by the external envelope, so that the current interrupter component is contained within the exterior envelope.

In certain embodiments, where a protective shroud or other exterior envelope is used, rather than being carried by the substrate that carries the LEDs, the current interrupter component may be otherwise contained within the exterior envelope so as to inhibit accidental removal of the current interrupter component during installation of the illumination unit. In such embodiments, an exterior envelope will at least partially surround at least part of the electrical circuit of which the LED(s) and the current interrupter component form a part, with the current interrupter component being contained within the exterior envelope.

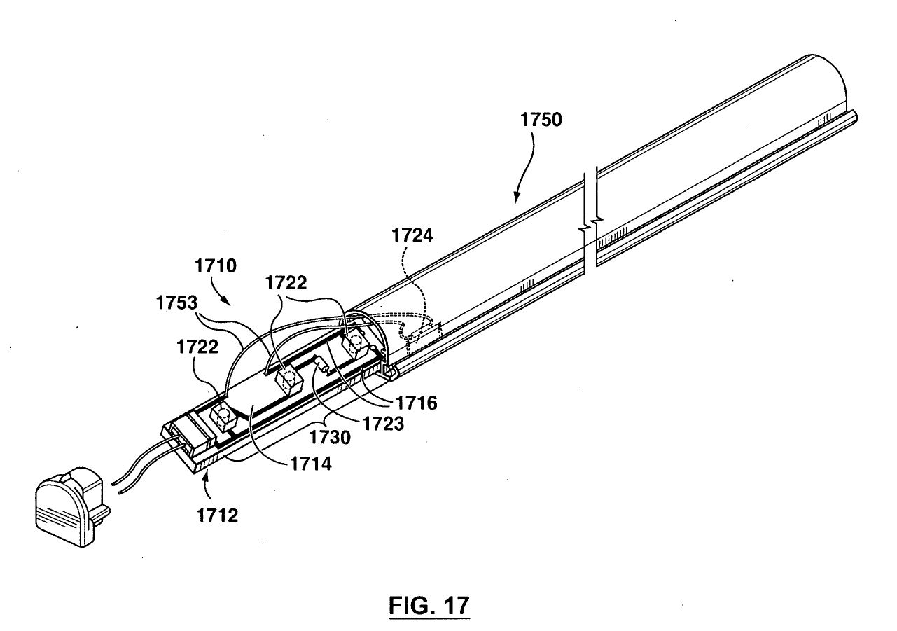

For example, as shown in FIG. 17, a light-carrying member 1710 similar to the light-carrying members 10, 710, 1610 described above is contained within a protective shroud 1750 which defines an exterior envelope. The light-carrying member 1710 comprises a printed circuit board 1712 having an upper surface 1714 on which are disposed a plurality of conductive pathways 1716, LEDs 1722 and resistors 1723, divided into sub-circuits 1730 in a manner analogous to the light-carrying members 10, 710, 1610. Conductive strips (not shown) similar to the conductive strips 18A, 18B on the light-carrying member 10 extend along the underside of the printed circuit board 1712 to complete the circuit. As with the case of the current interrupter components 24, 724, a current interrupter component 1724 is interposed in the electrical circuit so that the current interrupter component permits current flow within the electrical circuit when a parameter of the electrical circuit remains below a predetermined value and opens the electrical circuit in response to the parameter of the electrical circuit exceeding the predetermined value. Unlike with light-carrying members 10, 710, however, the current interrupter component 1724 is not carried by the printed circuit board 1712, but instead is secured to the interior surface of the protective shroud 1750 and coupled to the circuit on the printed circuit board 1712 by way of wires 1753. Thus, the current interrupter component 1724, even though not carried by the light-carrying member 1710, is still contained within the exterior envelope.

As indicated above, a protective shroud need not completely surround the electrical circuit, but may surround only part of the electrical circuit. For example, a protective shroud may surround only the LED(s) while leaving other parts of the electric circuit exposed, or may surround some LED(s) but not others. Alternatively, a protective shroud may surround only the portion of the electrical circuit that includes the current interrupter component.

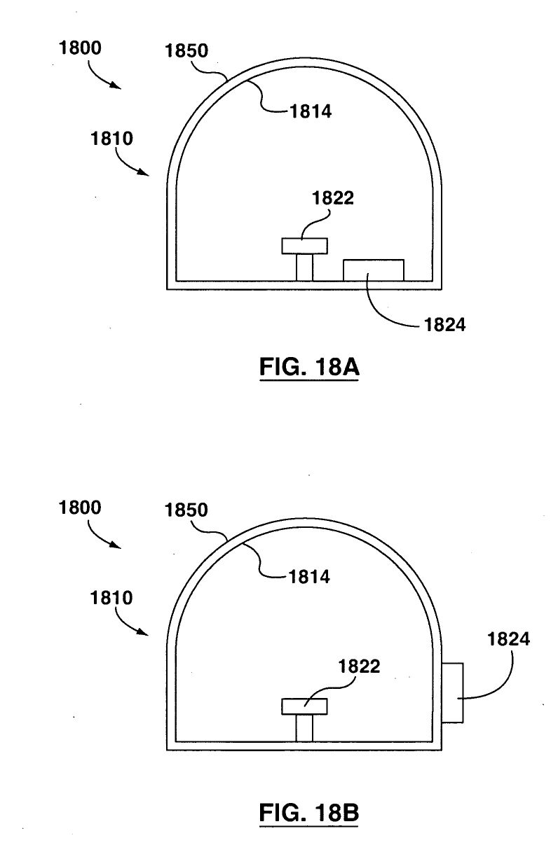

In another embodiment, shown in FIGS. 18A and 18B, the light-carrying member which carries the LEDs may include an integral protective shroud. An exemplary embodiment of such an illumination unit is indicated generally by the reference numeral 1800, and comprises a hollow translucent (i.e. completely or partially transparent) tube 1810 having an interior surface 1814 and an exterior surface 1850. One or more LEDs 1822 are mounted on the interior surface 1814 and the electrical connections, such as wires, electrical coupling elements, conductive pathways and/or conductive strips (these components are not specifically shown in FIGS. 18A and 18B) making up the electrical circuit are contained within the tube 1810 and arranged so as not to interfere with the desired light path from the LEDs. Thus, the light-carrying member is the protective shroud itself, namely the tube 1810. A current interrupter component 1824 is integrated into the electrical circuit of the illumination unit 1800, so that the current interrupter component 1824 permits current flow within the electrical circuit when a parameter of the electrical circuit remains below a predetermined value, and responsive to the parameter of the electrical circuit exceeding the predetermined value, opens the electrical circuit. As shown in FIG. 18A, the current interrupter component 1824 may be disposed on the interior surface 1814 of the tube 1810, or, as shown in FIG. 18B, may be disposed on the exterior surface 1850 of the tube 1810. This latter configuration is advantageous for embodiments where the current interrupter component 1824 is one which requires replacement or manual resetting after being tripped. In both configurations, since the current interrupter component 1824 is carried by the light-carrying member, namely the tube 1810, accidental removal of the current interrupter component 1824 during installation is unlikely.

One or more currently preferred embodiments have been described by way of example. It will be apparent to persons skilled in the art that a number of variations and modifications can be made without departing from the scope of the invention as defined in the claims.

What is claimed is:

1. An illumination unit, comprising:
at least one electrical coupling element for receiving electrical current from a current source and coupling the illumination unit into an electrical system;
a light-carrying member;
an electrical circuit adapted for electrical coupling to the current source via the electrical coupling element; the electrical circuit comprising:
at least one light-emitting diode carried by the light-carrying member; and
a current interrupter component interposed in the electrical circuit to:
(a) permit current flow within the electrical circuit when a parameter of the electrical circuit remains below a predetermined value; and
(b) responsive to the parameter of the electrical circuit exceeding the predetermined value, open the electrical circuit;
wherein the current interrupter component is carried by the light-carrying member.

2. The illumination unit of claim 1, wherein the parameter of the electrical circuit is electrical current therein and wherein the current interrupter component is a fuse.

3. The illumination unit of claim 1, wherein the current interrupter component is resettable.

4. The illumination unit of claim 3, wherein the current interrupter component is a polymeric positive temperature coefficient device that uses its internal temperature as a proxy for the electrical current in the electrical circuit and trips when its internal temperature exceeds a predetermined temperature, wherein after being tripped and opening the electrical circuit, the current interrupter component automatically resets to close the electrical circuit upon its internal temperature decreasing below the predetermined temperature.

5. The illumination unit of claim 3, wherein the current interrupter component is manually resettable.

6. The illumination unit of claim 1, further comprising a translucent tubular cover member in which the light-carrying member is removably mounted.

7. The illumination unit of claim 6, wherein the light-carrying member is removably slidably mounted in the cover member, and wherein the interior of the cover member has radially spaced internal projections positioned to receive the light-carrying member therebetween to maintain the light-carrying member in selectable different angular orientations in the cover member.

8. A storage compartment having a movable door and at least one illumination unit in accordance with claim 1 mounted on an interior portion of the compartment structure.

9. A storage compartment according to claim 8 wherein the door is vertically movable and wherein a pair of illumination units in accordance with claim 1 is mounted in the storage compartment and extending vertically therein adjacent respective opposite sides of the door interiorly thereof.

10. A storage compartment according to claim 9 wherein the illumination units are secured to respective door frame members.

11. An illumination unit comprising:
at least one electrical coupling element for receiving electrical current from a current source and coupling the illumination unit into an electrical system;
an electrical circuit adapted for electrical coupling to the current source via the electrical coupling element; the electrical circuit including:
at least one light emitting diode; and
a current interrupter component interposed in the electrical circuit to:
(a) permit current flow within the electrical circuit when a parameter of the electrical circuit remains below a predetermined value; and
(b) responsive to the parameter of the electrical circuit exceeding the predetermined value, open the electrical circuit;
and
an exterior envelope at least partially surrounding the electrical circuit, wherein the current interrupter component is contained within the exterior envelope.

12. The illumination unit of claim 11, wherein the current interrupter component is carried by a light-carrying member which also carries the at least one light emitting diode.

13. The illumination unit of claim 11, wherein the current interrupter component is mounted on an interior surface of the exterior envelope.

14. The illumination unit of claim 11, wherein the parameter of the electrical circuit is electrical current therein and wherein the current interrupter component is a fuse.

15. The illumination unit of claim 11, wherein the current interrupter component is resettable.

16. The illumination unit of claim 15, wherein the current interrupter component is a polymeric positive temperature coefficient device that uses its internal temperature as a proxy for the electrical current in the electrical circuit and trips when its internal temperature exceeds a predetermined temperature, wherein after being tripped and opening the electrical circuit, the current interrupter component automatically resets to close the electrical circuit upon its internal temperature decreasing below the predetermined temperature.

17. The illumination unit of claim 15, wherein the exterior envelope permits access to the current interrupter component and the current interrupter component is manually resettable.

18. The illumination unit of claim 11, wherein the exterior envelope is at least highly water-resistant and surrounds at least those components of the electrical circuit that would be adversely affected by contact with water.

19. The illumination unit of claim 18, wherein each light-emitting diode is at least highly water-resistant and at least a portion of each light-emitting diode is outside of the exterior envelope to facilitate illumination.

20. A vehicle having at least one illumination unit according to claim 18 disposed on an exterior surface thereof.
